(19) United States
(12) Patent Application Publication
(10) Pub. No.: US 2021/0060789 A1
(43) Pub. Date: Mar. 4, 2021

(54) ACTION ROBOT TOY

(71) Applicant: TOMY COMPANY, LTD., Tokyo (JP)

(72) Inventors: Gen NAGASHIMA, Tokyo (JP); Keita ICHIKAWA, Tokyo (JP)

(73) Assignee: TOMY COMPANY, LTD., Tokyo (JP)

(21) Appl. No.: 16/828,091

(22) Filed: Mar. 24, 2020

(30) Foreign Application Priority Data
Sep. 3, 2019 (JP) 2019-160384

(51) Int. Cl. B25J 11/00; B25J 9/12; B25J 9/04

(52) U.S. Cl. CPC B25J 11/003; A63H 3/28; B25J 9/04; B25J 9/126

(57) ABSTRACT

The action robot toy includes a robot main body, first and second shafts, first and second rotating members, first and second rotation devices, and a control device. The first rotating member includes a first tip end and a first base end being opposite to the first tip end. The second rotating member includes a second tip end and a second base end being opposite to the second tip end. The first and second base ends are rotatably linked to the robot main body via the first and second shafts respectively. The first and second rotation devices are configured to rotate the first and second rotating members. The first and second shafts extends in a direction, and the first and second rotating members are rotatable within a plane orthogonal to the direction. The robot main body is lifted by the first and second rotating members abutting a floor.

### CROSS-REFERENCE TO THE RELATED APPLICATION

The present application claims priority under 35 U.S.C. 119 to Japanese Patent Application No. 2019-160384 filed on Sep. 3, 2019. The entire content of Japanese Patent Application No. 2019-160384 is incorporated herein by reference.

### BACKGROUND

### Technical Field

The present invention relates to an action robot toy.

### Background Art

From the past, as action robot toy that performs dancing, known are items that detect the movement of an operator (user), and link the movement of the operator to a toy to be operated (Patent Document 1).

[Patent Document 1] Unexamined Patent Publication No. 2002-210260

[Patent Document 2] Patent Publication No. 4397412

### SUMMARY

Problems the Invention Is Intended to Solve

With this kind of action robot toy, though there is the interesting point of imitating people, the hands only move up and down, so there is the problem that the action mode is limited.

Also, as a robot toy, items are known for which not only the hands but also the legs are moved (Patent Document 2). With these items that move hands and legs, though there is an increase in action modes, a movement mechanism for moving the hands and legs is required, so there was the problem that the structure is complicated, and naturally becomes expensive.

The present invention was created considering these problems, and the purpose is to provide an action robot toy that has a simple structure, and has abundant action modes.

### Means for Solving the Problems

An action robot toy is provided in view of the above problems.

The action robot toy includes a robot main body, first and second shafts, first and second rotating members, first and second rotation devices, and a control device.

The first and second shafts are configured parallel to each other on the robot main body.

The first and second rotating members are provided corresponding to the first and second shafts respectively. The first rotating member includes a first tip end and a first base end being opposite to the first tip end. The second rotating member includes a second tip end and a second base end being opposite to the second tip end. The first and second tip ends project from the robot main body when the first and second rotating members are rotated. The first and second base ends are rotatably linked to the robot main body via the first and second shafts respectively.

The first and second rotation devices are configured to rotate the first and second rotating members.

The control device is configured to control the first and second rotation devices in rotating the first and second rotating members.

The first and second shafts extends in a direction, and the first and second rotating members are rotatable within a plane orthogonal to the direction.

The robot main body is lifted by the first and second rotating members abutting a floor.

### BRIEF DESCRIPTION OF THE DRAWINGS

FIG. 1 is a front side perspective view of an action robot toy of an embodiment seen from diagonally above.

FIG. 2 is a rear side perspective view of the action robot toy of the embodiment seen from diagonally below.

FIG. 3 is a front side perspective view of the action robot toy in a state with the front body outer shell of the robot main body removed seen from diagonally above.

FIG. 4 is a rear side perspective view of the action robot toy in a state with the rear body outer shell of the robot main body removed seen from diagonally above.

FIG. 5 is a perspective view showing a movement mechanism of the action robot toy.

FIG. 6A-6D are drawings showing the basic postures during dancing.

FIG. 7 is a block diagram showing a control configuration of the action robot toy.

FIG. 8 is a perspective view showing a dedicated controller.

### DETAILED DESCRIPTION OF THE PREFERRED EMBODIMENTS

Following, an embodiment of an action robot toy of the present invention is explained based on drawings.

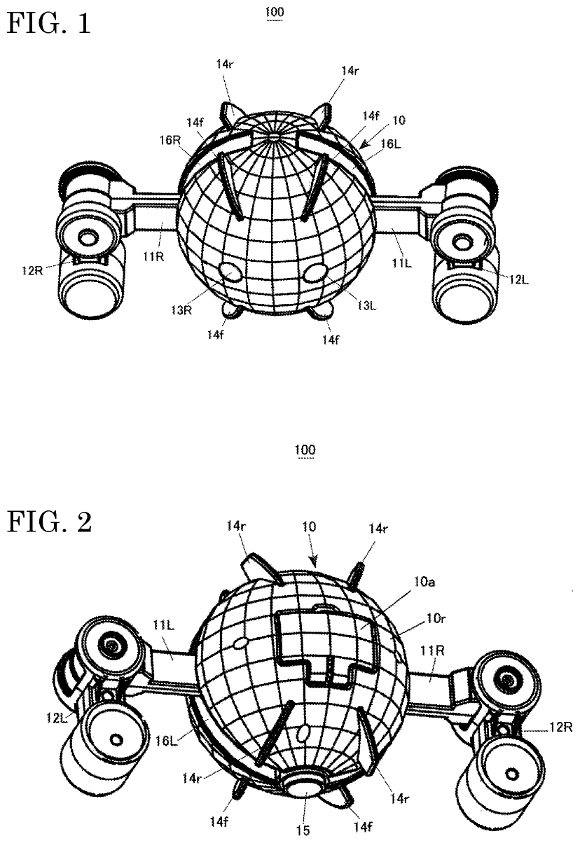

FIG. 1 is a front side perspective view of an action robot toy 100 of the embodiment seen from diagonally above, and FIG. 2 is a rear side perspective view of the action robot toy 100 seen from diagonally below.

The action robot toy 100 of the present embodiment comprises a spherical robot main body 10. The robot main body includes a upper-most part on a top end thereof. A first rotating piece 11L (an example of the first rotating piece) is provided at the left side of the robot main body 10, and a first rotating piece 11R (an example of the third rotating piece) is provided at the right side. Left and right means left and right when viewing from the action robot toy 100.

Each first rotating piece 11 (when not distinguishing between the left and right first rotating pieces 11L, 11R, these are called the first rotating pieces 11 (an example of the first rotating member)) rotates vertically independently. Also, a second rotating piece 12L (an example of the second rotating piece) is provided at the tip of the left first rotating piece 11L, and a second rotating piece 12R (an example of the fourth rotating piece) is provided at the tip of the right first rotating piece 11R. Each second rotating piece 12 (when not distinguishing between the left and right second rotating pieces 12L, 12R, these are called the second rotating pieces 12 (an example of the second rotating member)) rotates vertically independently. A rotating member is configured by this first rotating piece 11 and second rotating piece 12.

A left eye 13L and a right eye 13R are displayed on the front surface of the robot main body 10. Also, two each of projecting pieces 14f, 14r are provided on the upper part of the robot main body 10, and two each of projecting pieces 14f, 14r are provided on the lower part.

A circular rubber plate 15 is exposed at the lower end of the robot main body 10, and the robot main body 10 is able to rotate with the rubber plate 15 as the center.

This action robot toy 100 performs prescribed actions using combinations of rotating the left and right first rotating pieces 11L, 11R, rotating the left and right second rotating pieces 12L, 12R, and rotating the robot main body 10.

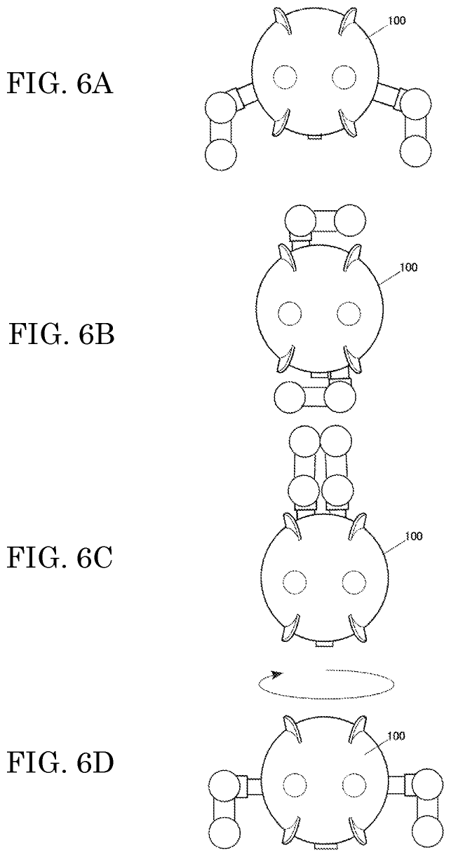

FIG. 6A to D show characteristic forms of the first rotating pieces 11 and the second rotating pieces 12 that can be taken by the action robot toy 100.

FIG. 6A shows a posture in which the first rotating pieces 11L, 11R extend diagonally downward with respect to the robot main body 10, and the second rotating pieces 12L, 12R are hanging. In this posture, the tips of the second rotating pieces 12L, 12R are touching ground, and the robot main body 10 is rising up from the ground plane. The rotating member can hold this state.

FIG. 6B shows the first rotating piece 11L extending below the robot main body 10, and the second rotating piece 12L tucked below the robot main body 10. Meanwhile, the form is such that the first rotating piece 11R extends above the robot main body 10, and the second rotating piece 12R covers the upper end of the robot main body 10. When in this form, by center of gravity movement, the action robot toy 100 rolls in the direction in which the tips of the second rotating pieces 12L, 12R face.

In FIG. 6C, the form is such that both of the first rotating pieces 11L, 11R extend upward with respect to the robot main body 10, and the tip end parts of the second rotating pieces 12L, 12R abut each other.

In FIG. 6D, the first rotating pieces 11L, 11R extend horizontally with respect to the robot main body 10, and the second rotating pieces 12L, 12R are in a hanging form. With this form, for example, the state is such that rotation is possible by the robot main body 10 with the rubber plate 15 as the center.

Following, the detailed configuration of the action robot toy 100 is explained.

### Robot Main Body 10

A recess 16L in a cut-through state that pierces vertically is formed at the left side of the robot main body 10, and a recess 16R in a cut-through state that pierces vertically is formed at the right side. A base end part (an example of the first base end) of the corresponding first rotating piece 11 is inserted in each recess 16 (when not distinguishing between the left and right recesses 16L, 16R, these are called the recesses 16), and is axially supported within the recess 16. Also, as shown in FIG. 2, a portion of a rear body outer shell 10r configures a swing door 10a that can be opened and closed by a hinge (not illustrated).

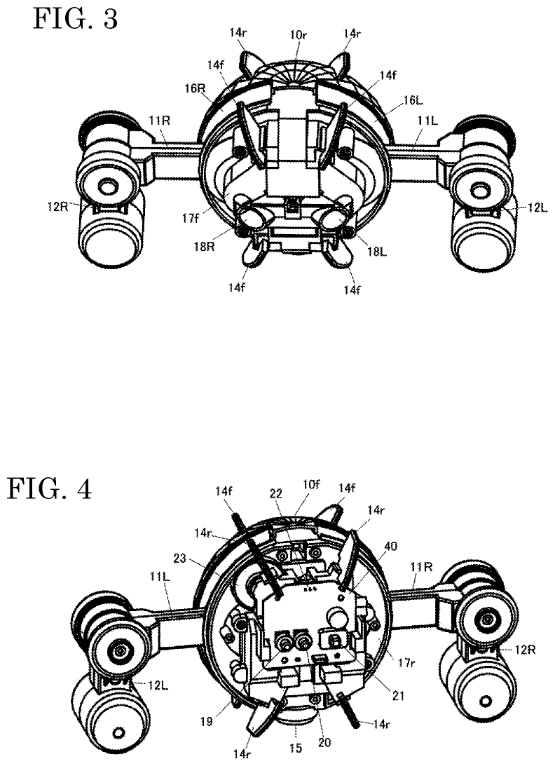

FIG. 3 is a front side perspective view of the action robot toy 100 in a state with the front body outer shell 10f removed seen from diagonally above.

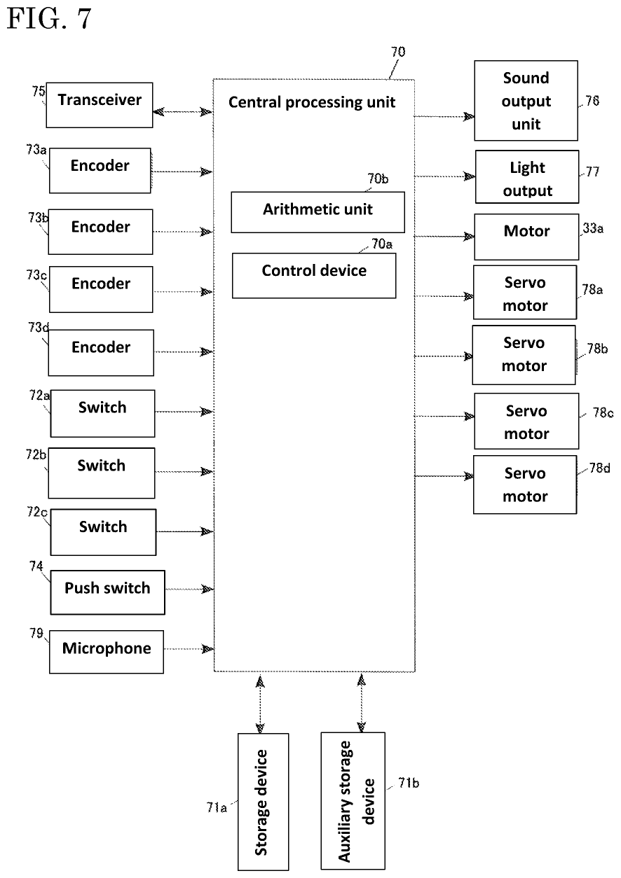

A front side mounted body 17f is provided on the front half of the robot main body 10. A tubular cover 18L is provided at the left side and a tubular cover 18R is provided on the right side on this front side mounted body 17f. One each of a light emitting diode (not illustrated) configuring a portion of a light output unit 77 (see FIG. 7) is installed in the interior of each tubular cover 18 (when not distinguishing between the left and right tubular covers 18L, 18R, these are called tubular covers 18). Also, two each of projecting pieces 14f are provided at the top and bottom of the front side mounted body 17f Each projecting piece 14f projects piercing the front body outer shell 10f.

FIG. 4 is a rear side perspective view of the action robot toy 100 in a state with the rear body outer shell 10r removed seen from diagonally above.

A rear side mounted body 17r is provided on the rear half of the robot main body 10. A partition plate 40 such as a board is attached to this rear side mounted body 17r. Provided on the partition plate 40 are buttons 19, 20 and a knob 21 for operating a corresponding switch, and a charging terminal 22. The buttons 19, 20, the knob 21, and the charging terminal 22 are exposed when the swing door 10a is opened. A battery (not illustrated) that is charged through the charging terminal 22 is provided on the rear side of the partition plate 40.

Also, a speaker 23 is attached to the rear side mounted body 17r. Furthermore, two each of the projecting pieces 14r are provided at the top and bottom of the rear side mounted body 17r. Each projecting piece 14r projects piercing the rear body outer shell 10r. Each of the four projecting pieces 14f and projecting pieces 14r are for stabilizing the orientation of the action robot toy 100.

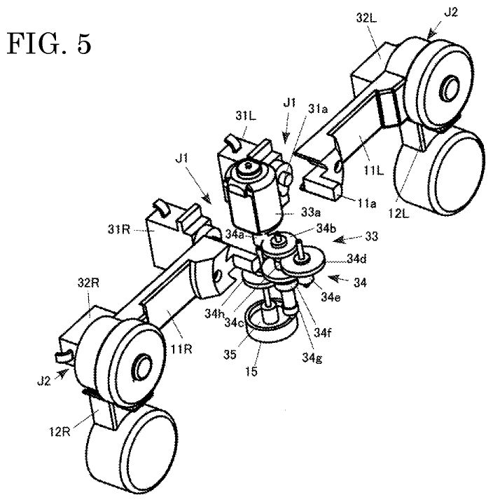

FIG. 5 is a perspective view showing an operating device of the action robot toy 100. With this drawing, the rear side half of the rotating member is removed.

The action robot toy 100 comprises: a left first rotating piece rotation device 31L (an example of the first rotation part) for rotating the left first rotating piece 11L; a right first rotating piece rotation device 31R for rotating the right first rotating piece 11R; a left second rotating piece rotation device 32L (an example of the second rotation part; the combination of the left first rotating piece rotation device 31L and the left second rotating piece rotation device 32L is an example of the first rotation device) for rotating the left second rotating piece 12L; and a right second rotating piece rotation device 32R for rotating the right second rotating piece 12R. The left first rotating piece rotation device 31L, the right first rotating piece rotation device 31R, the left second rotating piece rotation device 32L, and the right second rotating piece rotation device 32R are respectively configured from individual servo mechanisms. Each servo mechanism comprises a servo motor, and an encoder that measures the rotation position using a sensor and outputs position information as an electrical signal. It is also possible to use a rotation position detection unit such as a potentiometer instead of the encoder. Here, the rotation position detection unit, in addition to being used for position control of the first rotating pieces 11 and the second rotating pieces 12, can also be used to detect the position of the first rotating pieces 11 and the second rotating pieces 12 and register the movement of the action robot toy 100.

The left first rotating piece rotation device 31L and the right first rotating piece rotation device 31R are provided on a joint J1 inside the robot main body 10. Meanwhile, the left second rotating piece rotation device 32L and the right second rotating piece rotation device 32R are provided on a joint J2

Also, a body rotating device 33 for rotating the robot main body 10 is provided in the center of the robot main body 10. This body rotating device 33 comprises a motor 33a installed vertically, and a gear mechanism 34 linked to the motor 33a. With this body rotating device 33, the motor power is transmitted to a rotary plate 35 via gears 34a, 34b, 34c, 34d, 34e, 34f, 34g, and 34h. The rubber plate 15 is adhered to the bottom surface of the rotary plate 35. Also, when the motor 33a is operated, the rotary plate 35 tries to rotate, but the rubber plate 15 is gripping the play surface (ground plane), so without the rubber plate 15 rotating, the motor 33a and thus the robot main body 10 rotate by reaction.

### First Rotating Piece 11 and Second Rotating Piece 12

The joint J1 of the robot main body 10 and the first rotating piece 11 is formed by linking an output shaft 31a (an example of first and second shafts) of the first rotating piece rotation device 31 and a rotating shaft 11a of the first rotating piece 11.

Also, the joint J2 of the first rotating piece 11 and the second rotating piece 12 is a cylindrical shape having a center axis extending at a right angle to the rotation plane of the second rotating piece 12. This allows for smooth sliding on the ground plane with rotation.

Also, the tip end part of the second rotating piece 12 also has a cylindrical shape having a center axis extending at a right angle to the rotation plane of the second rotating piece 12. This allows for smooth sliding on the ground plane with rotation.

### Control Configuration

FIG. 7 shows the control configuration of the action robot toy 100.

The action robot toy 100 comprises as the control configuration a central processing unit 70, a main storage device 71a, and an auxiliary storage device 71b.

The central processing unit 70 comprises a control device 70a and an arithmetic unit 70b.

Prescribed programs and various data are stored in the auxiliary storage device 71b. As programs, a setting registration and playback program, etc. are stored. As data, data needed for executing each program, a plurality of music data, and operation data, etc., are stored. Music data and operation data stored in advance are associated 1 to 1. This associated music data and operation data are used during a demonstration mode, and it is possible to make the action robot toy 100 do an action (dancing) suited to the music. Also, as operation data, a plurality of templates are prepared. The templates are used during free dance mode. Music data and operation data can also be additionally stored in the auxiliary storage device 71b.

The central processing unit 70 reads the programs and various data as appropriate and executes control and calculation. The main storage device 71a is a part that becomes a work area, and programs and various data are temporarily stored as needed.

Also, the action robot toy 100 comprises: a switch 72a operated by the knob 21; switches 72b, 72c operated by the buttons 19, 20; encoders 73a to 73d included in the servo mechanism; and a push switch 74 placed on the head of the action robot toy 100. The switch 72a is a power switch, and switches 72b, 72c are variable definition type switches. Specifically, the switches 72b, 72c function as a determination button, a selection button, a reset button, etc., according to the program being executed. The push switch 74 is used to set and register the movement of the robot main body 10.

Also, the action robot toy 100 comprises: a transceiver 75; a sound output unit 76; the light output unit 77; the motor 33a; servo motors 78a to 78d included in each rotation device; and a microphone 79. The transceiver 75 performs communication with a dedicated controller, or a smart phone or tablet using Bluetooth (registered trademark), etc. The light output unit 77 is configured including the light emitting diode, and the sound output unit 76 is configured including the speaker 23. The microphone 79 is an item for picking up external sound.

### How to Play, and Action

Four modes of how to play with this action robot toy 100 are prepared. Each mode is explained hereafter. Selection of the mode is performed by operating the selection button or the determination button.

### 1. Free Dance Mode

This free dance mode is a mode in which the action robot toy 100 performs free dancing to music.

With this free dance mode, as music, it is possible to use music output from a smart phone, etc., for example. Of course, it is also possible to use music based on music data stored in the auxiliary storage device 71b of the action robot toy 100.

With this free dance mode, when music plays, a template is selected from among the operation data stored in the auxiliary storage device 71b, the first rotating piece 11 and the second rotating piece 12 are moved based on that template, and the action robot toy 100 performs free dancing.

In this case, with the first rotating piece 11 and the second rotating piece 12, it is possible to select one template, and to repeat movement based on that one template until the music ends, and also possible to have the first rotating piece 11 and the second rotating piece 12 move while exchanging the templates until the music ends, having the action robot toy 100 perform free dancing.

### 2. Control Mode

This control mode is a mode that moves the action robot toy 100 in real time by the player operating an outside controller. At this time as well, it is preferable to play music the same as when in the free dance mode.

With this control mode, as the outside controller, it is possible to use a dedicated controller 90, or a smart phone 92 or a tablet.

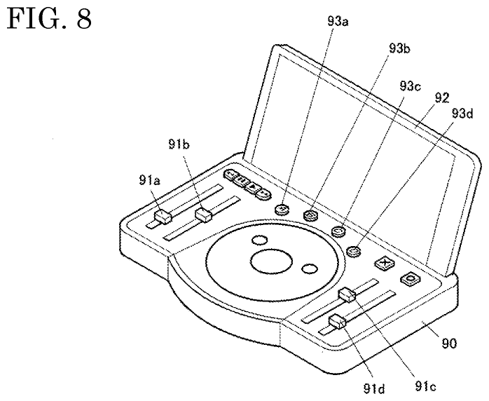

An example of the dedicated controller 90 is shown in FIG. 8. In the same drawing, code 92 shows a smart phone for playing music.

When using this dedicated controller 90, sliding knobs 91a to 91d having 1 to 1 correspondence for each of the first rotating piece 11 and the second rotating piece 12 are operated forward and back as appropriate. Having done that, an operation signal corresponding to the operation direction and the operation amount is transmitted to the action robot toy 100 from the dedicated controller 90, and at the action robot toy 100 that received that operating signal, the corresponding first rotating piece 11 and the second rotating piece 12 are moved according to the operating direction and operation amount of the knobs 91a to 91d. In this case, for sending and receiving of signals, for example, Bluetooth which is a short-range communication standard is used, so pairing is required before sending and receiving.

Meanwhile, when using the smart phone 92 or a tablet instead of the dedicated controller 90, when an operation application is installed in advance in the smart phone 92 or the tablet, an operation screen is displayed on the screen by that operation application, and a prescribed operation can be performed on that operation screen.

### 3. Program Mode

With this program mode, the player programs and sets and registers the movement of the action robot toy 100 in advance, and the action robot toy 100 is made to perform that set and registered movement. At this time as well, it is preferable to play music in the same manner as when in the free dance mode.

As a method for setting and registering in this case, though not particularly limited, there are roughly two methods that are possible.

The first method is a method of setting and registering directly to the action robot toy 100. In this case, the setting and registration is performed according to voice guidance output from the sound output unit 76.

In specific terms, the first rotating piece 11 and the second rotating piece 12 of the action robot toy 100 are actually moved until the desired form is reached, and when the desired form of the first rotating piece 11 and the second rotating piece 12 is reached, the push switch 74 is pressed via the head. By doing this, one form of the action robot toy 100 is registered as data. By performing this kind of operation a plurality of times, the movements of the action robot toy 100 are registered in the form of operation data in the auxiliary storage device 71b. When there is a wish to input rotation of the robot main body 10 midway, for example, it is possible to press the head of the action robot toy 100, or to press the button 19, etc., without operating the first rotating piece 11 and the second rotating piece 12, and also preferable to make it so that selection of the playback speed of the movement by the action robot toy 100 can be done by operating a specific button.

The second method is a method of using the dedicated controller 90 or a smart phone or a tablet to do setting and registering.

When using the dedicated controller 90, the first rotating piece 11 and the second rotating piece 12 of the action robot toy 100 are actually moved until a desired form is reached, and a first button (determination button) 93a is pressed when the first rotating piece 11 and the second rotating piece 12 reach the desired form. By doing this, one form of the action robot toy 100 is registered as data. This operation is performed a plurality of times, and by pressing the second button to fourth button (determination buttons) 93b to 93d in order, the determination signals are successively transmitted to the action robot toy 100, and the movement of the action robot toy 100 is registered in the form of operation data in the auxiliary storage device 71b. When there is a desire to input rotation of the robot main body 10 midway, for example, the head of the action robot toy 100 is pressed. Having done that, the push switch 74 is operated, and the rotation of the robot main body 10 is set and registered. In this case, when the head of the action robot toy 100 is pressed once, the action robot toy 100 is rotated in one direction by half a circumference midway in dancing, and when the head is pressed twice, the action robot toy 100 may be rotated by one full circumference in one direction midway in dancing. Also, instead of pressing the head of the action robot toy 100, by operating a specific button of the dedicated controller 90, rotation of the robot main body 10 is set, small round trip rotation is set, or alternatively, it is also possible to set rotation in the reverse direction. It is preferable to make it possible to select the playback speed of the movement by the action robot toy 100 by operating a specific button.

Meanwhile, when doing setting and registering using the smart phone 92 or the tablet, a registration application is installed in advance in the smart phone 90 or the tablet, and a registration screen is displayed on the screen using that registration application. A plurality of sample images of the form of the first rotating piece 11 and the second rotating piece 12 are displayed on this registration screen, for example. Also, a plurality of modes of the rotation of the robot main body 10 are displayed. Therefore, the player selects the form of the first rotating piece 11 and the second rotating piece 12 or the mode of the rotation of the robot main body 10 from among the sample images on the screen. By performing this a plurality of times, the movement of the action robot toy 100 is set. Also, the results of that setting are transmitted to the action robot toy 100. By doing this, the movement of the action robot toy 100 is set and registered.

With this program mode, the first rotating piece 11 and the second rotating piece 12 are moved in order of setting and registration based on the set and registered motion data. In this case as well, it is preferable to make it possible to set the playback speed on the screen.

### 4. Demonstration Mode

This demonstration mode has the action robot toy 100 perform movement using operation data that has been associated with music data.

With this demonstration mode, together with playback of music, the action robot toy 100 performs movement suited to that.

Above, we explained an embodiment of the present invention, but the present invention is not limited to the abovementioned embodiment, and it goes without saying that various modifications are possible.

For example, with the abovementioned embodiment, a case of attaching the second rotating pieces 12 on the tip end parts of the first rotating pieces 11 was explained, but it is also possible to have only the first rotating pieces 11. This is because with only the first rotating pieces 11 as well, the rotation range is broad, and being able to raise up the robot main body 10 gives an element of surprise, making it is possible to provide an interesting action robot toy 100.

Also, with the abovementioned embodiment, the player was able to set the rotation of the robot main body 10, but it is also possible to have rotation of the robot main body 10 performed when the first rotating pieces 11 and the second rotating pieces 12 are in a prescribed form, and also possible to have rotation of the robot main body 10 performed irregularly.

Also, with the abovementioned embodiment, the form of both the first rotating pieces 11 and the second rotating pieces 12 was set and registered, but it is also possible to set and register only the form of the first rotating pieces 11, and to have the second rotating pieces 12 do automatic reciprocating rotation when the first rotating pieces 11 are in a prescribed form.

### Effect of the Invention

The two rotating members are rotated vertically, and when rotated downward, this is recognized as a leg touching ground, and when upward, this is recognized as a hand. In this way, each rotating member becomes a leg or a hand, so the structure is simple. Also, when the rotating member is positioned downward, it is possible to lift up the robot main body, so it is possible to realize a novel action robot toy.

With the second means, the configuration is such that the tip end parts abut each other when the tip end parts of the two rotating members rise simultaneously, so it is possible to exude an image like hands clapping above the head.

With the third means, the robot main body is a spherical body, so it is possible to play even if upside down.

With the fourth means, using a projecting piece, the plane including two shafts is parallel to the ground plane, so it is possible to have stable action.

With the fifth means, the robot main body itself is configured to rotate, so it is possible to increase the variations in action.

With the sixth means, it is possible for the player to be involved in the movement of the action robot toy, so it is possible to realize a highly interesting action robot toy.

With the seventh means, it is possible to set the movement by actually moving the two rotating members in a desired form, so it is possible to perform settings intuitively.

With the eighth means, it is possible to have the action robot toy perform action together with music, so it is possible to realize a more highly interesting action robot toy.

With the ninth means, since each rotating member is configured from the first rotating piece and the second rotating piece, compared to a case of being configured by a single member, it is possible to have more delicate and complex action.

With the tenth means, it is possible for the player to be involved in the movement of the action robot toy, so it is possible to realize a more highly interesting action robot toy.

With the eleventh means, it is possible to have the robot main body roll by having the first rotating piece and the second rotating piece be in a prescribed position, so it is possible to increase the variation in actions.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims. In the drawings, the size and relative sizes of layers and regions may be exaggerated for clarity. Like numbers refer to like elements throughout. The terminology used herein is for the purpose of describing particular embodiments only and is not intended to be limiting of the invention. As used herein, the singular forms “a”, “an” and “the” are intended to include the plural forms as well, unless the context clearly indicates otherwise. As used herein, the term “and/or” includes any and all combinations of one or more of the associated listed items and may be abbreviated as “/”. It will be understood that, although the terms first, second, etc. may be used herein to describe various elements, these elements should not be limited by these terms. Unless indicated otherwise, these terms are only used to distinguish one element from another. For example, a first object could be termed a second object, and, similarly, a second object could be termed a first object without departing from the teachings of the disclosure. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. It will be understood that when an element is referred to as being “connected” or “coupled” to or “on” another element, it can be directly connected or coupled to or on the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.). However, the term “contact,” as used herein refers to direct contact (i.e., touching) unless the context indicates otherwise. Terms such as “same,” “planar,” or “coplanar,” as used herein when referring to orientation, layout, location, shapes, sizes, amounts, or other measures do not necessarily mean an exactly identical orientation, layout, location, shape, size, amount, or other measure, but are intended to encompass nearly identical orientation, layout, location, shapes, sizes, amounts, or other measures within acceptable variations that may occur, for example, due to manufacturing processes. The term “substantially” may be used herein to reflect this meaning. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

What is claimed is:

1. An action robot toy, comprising:
a robot main body;
first and second shafts being configured parallel to each other on the robot main body;
first and second rotating members provided corresponding to the first and second shafts respectively, the first rotating member including a first tip end and a first base end being opposite to the first tip end, the second rotating member including a second tip end and a second base end being opposite to the second tip end, the first and second tip ends projecting from the robot main body when the first and second rotating members are rotated, the first and second base ends being rotatably linked to the robot main body via the first and second shafts respectively;
first and second rotation devices being configured to rotate the first and second rotating members; and
a control device being configured to control the first and second rotation devices in rotating the first and second rotating members,
the first and second shafts extending in a direction,
the first and second rotating members being rotatable within a plane orthogonal to the direction,
the robot main body being lifted by the first and second rotating members abutting a floor.

2. The action robot toy according to claim 1, wherein
the robot main body has an upper-most part,
when the first and second rotating members are located higher than the upper-most part, the first and second tip end parts are configured to abut to each other.

3. The action robot toy according to claim 1, wherein
the robot main body has a spherical body, and
the first and second shafts are provided at equal distance from a center of the robot main body.

4. The action robot toy according to claim 3, wherein
the robot main body includes a body rotating device being configured to rotate the robot main body, and
the body rotating device includes
a rotating shaft extending vertically through the center of the spherical body,
a rotary plate being attached to the rotating shaft, where the rotary plate includes a rubber attached to a part projecting from a bottom surface of the robot main body and touching the floor,
a motor being configured on the robot main body, and
a power transmission mechanism being configured on the robot main body to transmit power from the motor to the rotary plate.

5. The action robot toy according to claim 1, further comprising
a projecting piece configured outside the robot main body to hold the robot main body in order for a plane including the first and second shafts is approximately parallel to the floor.

6. The action robot toy according to claim 1, comprising
an operation setting means being configured for a user to set movement of the first and second rotating members, and
a storage unit being configured to store operation data form the movement, wherein
the control device is configured to control the operation of the first and second rotation devices based on the operation data stored in the storage unit.

7. The action robot toy according to claim 6, further comprising
first and second servo mechanisms, wherein
the first and second rotation devices are made of the first and second servo mechanisms respectively and include first and second rotation position detection units, and
the operation setting means is configured to set the movement of the first and second rotating members using the rotation position detection units by a user moving the first and second rotating members.

8. The action robot toy according to claim 6, further comprising
a sound output unit, wherein
music data is stored in the storage unit, and
the control device is configured to control the operation of the first and second rotation devices while outputting music from the sound output unit based on the music data stored in the storage unit.

9. The action robot toy according to claim 1, wherein
the first rotating member includes first and second rotating pieces,
the first rotating piece is configured at a side of the first base end part,
the second rotating piece is configured at a side of the first tip end part, and is attached to the first rotating piece via a joint to be rotatable, and
the first rotation device includes a first rotation part being configured to rotate the first rotating piece, and a second rotation part being configured to rotate the second rotating piece.

10. The action robot toy according to claim 9, wherein
each of the first and second rotation devices is configured from the servo mechanism including a rotation position detection unit, and
the operation setting means is configured to set the movement of the first and second rotating members using the rotation position detection unit by a user moving the first rotating piece and the second rotating piece.

11. The action robot toy according to claim 9, wherein
the second rotating member includes third and fourth rotating pieces,
the third rotating piece is configured at a side of the second base end part,
the fourth rotating piece is configured at a side of the second tip end part, and is attached to the third rotating piece via a joint to be rotatable
the robot main body rolls in a direction in which tips of the second and fourth rotating pieces face in a state in which
the first rotating piece is in contact with the floor,
the second rotating piece is tucked under the robot main body,
the first rotating piece is positioned above the robot main body, and
the second rotating piece covers above the robot main body.
